(19) United States
(12) Patent Application Publication
(10) Pub. No.: US 2026/0340678 A1
(43) Pub. Date: Oct. 29, 2026

(54) METHOD, SYSTEM AND NON-TRANSITORY COMPUTER-READABLE RECORDING MEDIUM SUPPORTING ADVERTISEMENT LINKED TO METAVERSE PLATFORM

(71) Applicant: REDBRICK INC., Seoul (KR)

(72) Inventor: Yeongmo YANG, Hwaseong-si Gyeonggi-do (KR)

(73) Assignee: REDBRICK INC., Seoul (KR)

(21) Appl. No.: 19/123,146

(22) PCT Filed: Oct. 23, 2023
(86) PCT No.: PCT/KR2023/016507

§ 371 Date: Jun. 24, 2025

(30) Foreign Application Priority Data
Oct. 24, 2022 (KR) 10-2022-0137825

(51) Int. Cl. G06Q 30/0251; G06Q 30/0241

(52) U.S. Cl. CPC G06Q 30/0251; G06Q 30/0276

(57) ABSTRACT

According to one aspect of the present invention, there is provided is a method for supporting advertisement linked to a metaverse platform, the method comprising the steps of: acquiring information on a content for an advertisement linked to at least one metaverse platform; and determining execution of the content for the advertisement with reference to a user interaction in the at least one metaverse platform.

### FIELD OF THE INVENTION

The present invention relates to a method, system, and non-transitory computer-readable recording medium for supporting advertisement linked to a metaverse platform.

### BACKGROUND

The recent pandemic environment caused by the coronavirus has curtailed activities and interactions in the real world, so that people's thirst and desire for connections and relationships have led them to enter and engage in a virtual world or metaverse.

The concept of the metaverse, the technology for implementing the metaverse, and the goods and services actually experienced or used through the metaverse have existed before. However, the metaverse is rapidly expanding into all industries such as marketing, concerts, and healthcare after the pandemic, and the importance of the metaverse as a hyper-connected and hyper-realistic digital world is expected to further increase in human life.

Meanwhile, attempts are ongoing to find future directions in the field of metaverse advertising, which is showing relatively low performance and preparation both practically and academically compared to the activity and expandability of the metaverse economy that has been rapidly gaining attention and growing in a short period.

However, only basic and fragmented researches have been conducted on technical aspects such as virtual reality (VR), augmented reality (AR), and mixed reality (MR), and researches on specific advertising methods within the metaverse remain insufficient.

In this connection, the inventor(s) present a technique for acquiring information on a content for an advertisement linked to at least one metaverse platform, and determining execution of the content for the advertisement with reference to a user interaction in the at least one metaverse platform.

### PRIOR ART DOCUMENTS

### Patent Documents

(Patent Document 1) Korean Registered Patent Publication No. 10-2360945 (Feb. 4, 2022)

### SUMMARY OF THE INVENTION

One object of the present invention is to solve all the above-described problems in the prior art.

Another object of the invention is to specify a user's approach to an advertisement in a metaverse platform as property information of a content for the advertisement associated with an execution condition of the content is set on the basis of the user's interaction.

Yet another object of the invention is to increase incentives for creators to generate creative contents for advertisements by differentially determining rewards provided to the content creators depending on execution of contents for advertisements.

The representative configurations of the invention to achieve the above objects are described below.

According to one aspect of the invention, there is provided a method for supporting advertisement linked to a metaverse platform, the method comprising the steps of: acquiring information on a content for an advertisement linked to at least one metaverse platform; and determining execution of the content for the advertisement with reference to a user interaction in the at least one metaverse platform.

According to another aspect of the invention, there is provided a system for supporting advertisement linked to a metaverse platform, the system comprising: a content acquisition unit configured to acquire information on a content for an advertisement linked to at least one metaverse platform; and a content management unit configured to determine execution of the content for the advertisement with reference to a user interaction in the at least one metaverse platform.

In addition, there are further provided other methods and systems to implement the invention, as well as non-transitory computer-readable recording media having stored thereon computer programs for executing the methods.

According to the invention, it is possible to specify a user's approach to an advertisement in a metaverse platform as property information of a content for the advertisement associated with an execution condition of the content is set on the basis of the user's interaction.

According to the invention, it is possible to increase incentives for creators to generate creative contents for advertisements by differentially determining rewards provided to the content creators depending on execution of contents for advertisements.

### BRIEF DESCRIPTION OF THE DRAWINGS

FIG. 1 schematically shows the configuration of an entire system for supporting advertisement linked to a metaverse platform according to one embodiment of the invention.

FIG. 2 specifically shows the internal configuration of an advertisement support system according to one embodiment of the invention.

### DESCRIPTION OF THE REFERENCE NUMERALS

100: communication network
200: advertisement support system
210: content acquisition unit
220: content management unit
230: communication unit
240: control unit

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

The term “content” or “contents” as used herein encompasses digital information or individual information elements comprised of text, symbol, speech, sound, image, video, and the like, which are accessible via communication networks. For example, such contents may comprise data such as text, image, video, audio, and links (e.g., web links) or a combination of at least two types of such data.

Further, the term “metaverse” as used herein is a combination of the word “meta” meaning transcendence that unites reality and virtuality, and the word “verse” meaning a world, and may refer to a 3D-based virtual world in which a person conducts daily or economic activities through an avatar representing himself/herself in real life. The metaverse platform according to one embodiment of the invention is not limited to technical fields such as gaming, business, and video chatting, and may include Minecraft, Roblox, Naver's Geppetto, Fortnite, Nvidia's Enterprise, Facebook's Horizon, Google's Starline, and the like.

Hereinafter, various preferred embodiments of the invention will be described in detail with reference to the accompanying drawings to enable those skilled in the art to easily implement the invention.

### Configuration of the Entire System

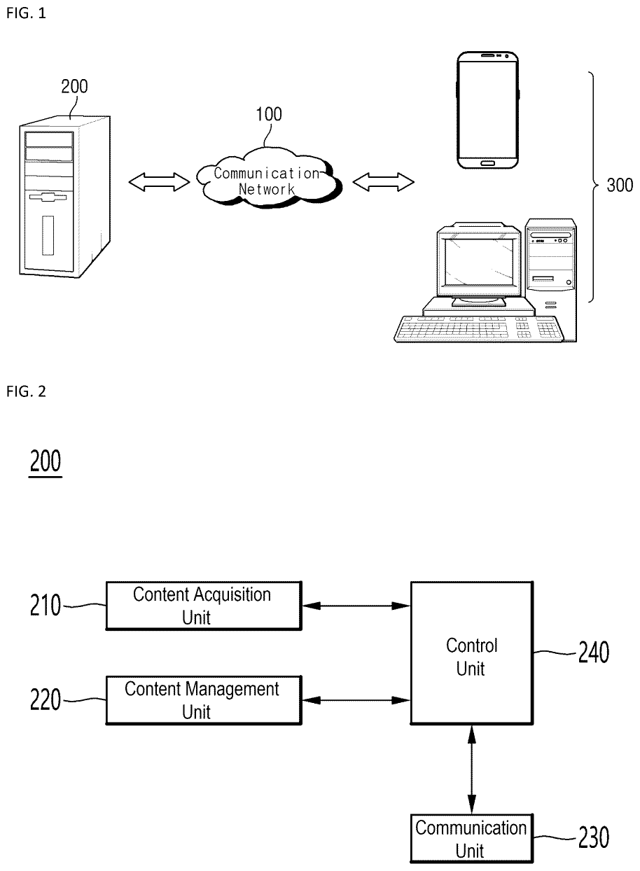

FIG. 1 schematically shows the configuration of the entire system for supporting advertisement linked to a metaverse platform according to one embodiment of the invention.

As shown in FIG. 1, the entire system according to one embodiment of the invention may comprise a communication network 100, an advertisement support system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the advertisement support system 200 according to one embodiment of the invention may function to acquire information on a content for an advertisement linked to at least one metaverse platform, and determine execution of the content for the advertisement with reference to a user interaction in the at least one metaverse platform.

The configuration and functions of the advertisement support system 200 according to the invention will be discussed in more detail below.

Next, the device 300 according to one embodiment of the invention is digital equipment capable of connecting to and then communicating with the advertisement support system 200, and any type of digital equipment having a memory means and a microprocessor for computing capabilities, such as smart phones, tablets, smart watches, smart bands, smart glasses, desktop computers, notebook computers, workstations, personal digital assistants (PDAs), web pads, and mobile phones, may be adopted as the device 300 according to the invention.

In particular, the device 300 may include an application (not shown) for assisting a user to receive services according to the invention from the advertisement support system 200. The application may be downloaded from the advertisement support system 200 or an external application distribution server (not shown). Meanwhile, the characteristics of the application may be generally similar to those of a content acquisition unit 210, a content management unit 220, a communication unit 230, and a control unit 240 of the advertisement support system 200 to be described below. Here, at least a part of the application may be replaced with a hardware device or a firmware device that may perform a substantially equal or equivalent function, as necessary.

### Configuration of the Advertisement Support System

Hereinafter, the internal configuration of the advertisement support system 200 200 crucial for implementing the invention and the functions of the respective components thereof will be discussed.

FIG. 2 specifically shows the internal configuration of the advertisement support system 200 according to one embodiment of the invention.

As shown in FIG. 2, the advertisement support system 200 according to one embodiment of the invention may comprise a content acquisition unit 210, a content management unit 220, a communication unit 230, and a control unit 240. According to one embodiment of the invention, at least some of the content acquisition unit 210, the content management unit 220, the communication unit 230, and the control unit 240 may be program modules to communicate with an external system (not shown). The program modules may be included in the advertisement support system 200 in the form of operating systems, application program modules, and other program modules, while they may be physically stored in a variety of commonly known storage devices. Further, the program modules may also be stored in a remote storage device that may communicate with the advertisement support system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the advertisement support system 200 has been described as above, and it will be apparent to those skilled in the art that at least a part of the components or functions of the advertisement support system 200 may be implemented in the device 300 or a server (not shown) or included in an external system (not shown), as necessary.

First, the content acquisition unit 210 according to one embodiment of the invention may acquire information on a content for an advertisement linked to at least one metaverse platform.

The information on the content for the advertisement according to one embodiment of the invention may refer to information on composition, properties, or generation of the content for the advertisement.

For example, the content acquisition unit 210 may acquire the information on the content for the advertisement which comprises data such as text, images, videos, audio, and links (e.g., web links) for the advertisement, or a combination of at least two types of such data.

As another example, the content acquisition unit 210 may acquire the information on the content for the advertisement whose properties are set regarding whether to execute (or activate) the advertisement.

As another example, the content acquisition unit 210 may acquire the information on the content for the advertisement which is generated via a user interface (UI) or user experience (UX) provided by the advertisement support system 200.

Specifically, the advertisement support system 200 according to one embodiment of the invention may provide a UI or UX for supporting creation of the content for the advertisement, and the information on the content for the advertisement linked to the at least one metaverse platform may be generated via the Ul or UX.

More specifically, the UI or UX according to one embodiment of the invention is intended to support advertisement generation such that the content for the advertisement may be generated or produced through various modules (e.g., 3D models, 3D assets, videos, text, web, speech, and UI components) provided via the Ul or UX.

Meanwhile, the content acquisition unit 210 according to one embodiment of the invention may set property information of the content for the advertisement associated with an execution condition of the content. Here, the property information of the content according to one embodiment of the invention may refer to information on properties regarding how the content for the advertisement is executed in response to a user interaction in the at least one metaverse platform.

Specifically, the property information of the content according to one embodiment of the invention may be set on the basis of at least one of a property panel, text coding, and block coding.

For example, the property panel according to one embodiment of the invention may refer to a tool for controlling the execution of the content for the advertisement according to specifications and coordinates during the process of generating or editing the content. If it is assumed that three-dimensional coordinates are set via the property panel (e.g., the x-coordinate is set to 7, the y-coordinate is set to 14, and the z-coordinate is set to 6), the property information of the content may be set such that the content for the advertisement is automatically executed on the basis of a location-related user interaction in the metaverse platform (e.g., the user being located at the specified three-dimensional coordinates or the user being located in a Euclidean space corresponding to the specified three-dimensional coordinates from a fixed location where the content for the advertisement will be executed).

As another example, the property information of the content according to one embodiment of the invention may be set such that the content for the advertisement is automatically executed on the basis of a game-related user interaction in the metaverse platform (e.g., the user winning a game or the user completing a quest in the game) via text coding.

As another example, the property information of the content according to one embodiment of the invention may be set such that the content for the advertisement is automatically executed on the basis of a consumption-related user interaction in the metaverse platform (e.g., the user purchasing a specific item) via block coding.

Further, the property information of the content according to one embodiment of the invention may be set such that the content for the advertisement is automatically executed on the basis of multiple user interactions in multiple metaverse platforms.

As the property information of the content for the advertisement associated with the execution condition of the content is set on the basis of a user interaction according to one embodiment of the invention as described above, it is possible to specify the user's approach to the advertisement in the metaverse platform.

However, the methods of setting the property information of the content and the user interactions in the metaverse platform included in the property information according to one embodiment of the invention as described above are only exemplary and may be diversely changed as long as the objects of the invention may be achieved.

Next, the content management unit 220 may determine execution of the content for the advertisement with reference to a user interaction in the at least one metaverse platform.

Specifically, the content management unit 220 according to one embodiment of the invention may determine the execution of the content for the advertisement with reference to the property information of the content set on the basis of the user interaction in the metaverse platform.

Further, the content management unit 220 according to one embodiment of the invention may dynamically determine the execution of the content for the advertisement in response to the user interaction matching at least a part of the set property information of the content.

For example, when the property information of the content for the advertisement associated with the execution condition of the content is set on the basis of location-related and consumption-related user interactions, the content management unit 220 according to one embodiment of the invention may execute the content for the advertisement if at least one of the user's location and the user's consumption in the metaverse platform matches the execution condition of the content for the advertisement, and may interrupt the content for the advertisement if the user's location and the user's consumption do not match the execution condition of the content for the advertisement.

As another example, when the property information of the content for the advertisement associated with the execution condition of the content (e.g., a content for a first advertisement is executed in response to a consumption-related user interaction, and a content for a second advertisement is executed in response to a location-related user interaction) is set on the basis of priorities of a plurality of user interactions (e.g., a consumption-related user interaction takes priority over a location-related user interaction), the content management unit 220 according to one embodiment of the invention may execute the content for the advertisement in the metaverse platform on the basis of priorities of a plurality of user interactions (e.g., the content for the first advertisement is executed if the user's location and the user's consumption match the execution condition of the content for the advertisement).

Meanwhile, the content management unit 220 according to one embodiment of the invention may determine a reward for the execution of the content for the advertisement.

For example, the content management unit 220 according to one embodiment of the invention may differentially determine a reward to be provided to a content creator in proportion to the number of executions of the content for the advertisement.

As another example, the content management unit 220 according to one embodiment of the invention may differentially determine the reward to be provided to the content creator with reference to a weight of a user interaction regarding the execution of the content for the advertisement. More specifically, when the execution condition of the content for the advertisement according to one embodiment of the invention is associated with location-related and consumption-related user interactions, it may be determined that a greater reward is provided to the content creator when the content for the advertisement is executed in response to the consumption-related user interaction than when the content for the advertisement is executed in response to the location-related user interaction.

By differentially determining the reward to be provided to the content creator depending on the execution of the content for the advertisement according to one embodiment of the invention as described above, it is possible to increase an incentive for the content creator to generate a creative content for an advertisement.

However, the criteria for differentially determining the reward to be provided to the content creator according to one embodiment of the invention are not limited but may be diversely changed as long as the objects of the invention may be achieved.

Next, the communication unit 230 according to one embodiment of the invention may function to enable data transmission/reception from/to the content acquisition unit 210 and the content management unit 220.

Lastly, the control unit 240 according to one embodiment of the invention may function to control data flow among the content acquisition unit 210, the content management unit 220, and the communication unit 230. That is, the control unit 240 according to one embodiment of the invention may control data flow into/out of the advertisement support system 200 or data flow among the respective components of the advertisement support system 200, such that the content acquisition unit 210, the content management unit 220, and the communication unit 230 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for supporting advertisement linked to a metaverse platform, the method comprising the steps of:
acquiring information on a content for an advertisement linked to at least one metaverse platform; and
determining execution of the content for the advertisement with reference to a user interaction in the at least one metaverse platform.

2. The method of claim 1, wherein in the acquiring step, a user interface (UI) or user experience (UX) for supporting creation of the content for the advertisement is provided.

3. The method of claim 1, wherein in the acquiring step, property information of the content for the advertisement associated with an execution condition of the content is set.

4. The method of claim 3, wherein in the acquiring step, the property information of the content is set on the basis of at least one of a property panel, text coding, and block coding.

5. The method of claim 3, wherein in the determining step, the execution of the content for the advertisement is dynamically determined in response to the user interaction matching at least a part of the set property information of the content.

6. The method of claim 1, further comprising the step of determining a reward for the execution of the content for the advertisement.

7. A non-transitory computer-readable recording medium having stored thereon a computer program for executing the method of claim 1.

8. A system for supporting advertisement linked to a metaverse platform, the system comprising:
a content acquisition unit configured to acquire information on a content for an advertisement linked to at least one metaverse platform; and
a content management unit configured to determine execution of the content for the advertisement with reference to a user interaction in the at least one metaverse platform.

9. The system of claim 8, wherein a user interface (UI) or user experience (UX) for supporting creation of the content for the advertisement is provided.

10. The system of claim 8, wherein the content acquisition unit is configured to set property information of the content for the advertisement associated with an execution condition of the content.

11. The system of claim 10, wherein the property information of the content is set on the basis of at least one of a property panel, text coding, and block coding.

12. The system of claim 10, wherein the content management unit is configured to dynamically determine the execution of the content for the advertisement in response to the user interaction matching at least a part of the set property information of the content.

13. The system of claim 8, wherein the content management unit is configured to determine a reward for the execution of the content for the advertisement.
